(19) United States
(12) Patent Application Publication
(10) Pub. No.: US 2014/0035792 A1
(43) Pub. Date: Feb. 6, 2014

(54) Microstrip-Fed Crossed Dipole Antenna

(71) Applicant: Dielectric, LLC, Raymond, ME (US)

(72) Inventors: John L. Schadler, Raymond, ME (US); Jon Hanson, Raymond, ME (US)

(21) Appl. No.: 13/959,256

(22) Filed: Aug. 5, 2013

Related U.S. Application Data
(60) Provisional application No. 61/679,535, filed on Aug. 3, 2012.

(51) Int. Cl. H01Q 21/26; H01Q 21/00

(52) U.S. Cl. CPC H01Q 21/26; H01Q 21/0087
USPC 343/798; 29/600

(57) ABSTRACT

A panel antenna includes a microstrip-fed radiator array, each radiator being a crossed dipole, with the monopoles of the dipole being loops that are electrically closed and hybrid coupled to the adjacent loops within the radiator. The loops are spaced away from a ground plane by approximately a quarter wavelength, using support straps that function as mechanical supports and couplers from the microstrip feed. Each four loops and four support straps and a base can be cast as a single piece, for example, since the shorted ends of the support straps are a quarter wavelength away from the loops. The feed system uses asymmetric microstrip power dividers to provide branch feed to the dipoles. Coupling between the feed and the loops uses the support straps and terminates in a stub that defines the impedance.

### CROSS-REFERENCE TO RELATED APPLICATIONS

This application claims the benefit from U.S. Provisional Application No. 61/679,535 filed on Aug. 3, 2012, which is hereby incorporated by reference in its entirety for all purposes as if fully set forth herein. This application is related to U.S. Provisional Application No. 61/679,589 filed on Aug. 3, 2012, which is hereby incorporated by reference in its entirety for all purposes as if fully set forth herein.

### FIELD OF THE INVENTION

The invention relates generally to radio-frequency (RF) electromagnetic signal communication antennas. More particularly, the invention relates to directional antenna radiators and associated signal distribution apparatus for low- to medium-power transmitting and transceiver functions. Even more particularly, the invention relates to directional antenna radiators and associated signal distribution apparatus for low- to medium-power transmitting and transceiver functions, wherein the radiators and associated signal distribution apparatus are configurable to support single or dual feed and linear or circular (elliptical to any chosen extent) polarization.

### BACKGROUND OF THE INVENTION

A number of concepts are not present in the prior art and may enhance performance, increase reliability, lower material and/or labor costs, etc., each of which can be separately beneficial, particularly in high-volume and cost-sensitive applications.

Panel antenna beam characteristics such as dip angle (i.e., elevation compared to perpendicular to an integral ground plane) and beam height (typically gain-related) have nominal values based on antenna design. The prior art includes typical inputs and outputs that terminate in small-diameter, polymer-filled, and thus relatively lossy coaxial lines. Such prior art embodiments would not be readily adaptable to lower-loss signal distribution technologies such as stripline, microstrip, air-filled coax, etc., nor to structural methods not relying on circuit board techniques, with strength depending on lossy reinforced polymer construction. The arrangements described may have other drawbacks, as well, so that what is needed in the art is a technology capable of higher efficiency than existing practice.

### SUMMARY OF THE INVENTION

The foregoing needs are met, to a great extent, by the invention, wherein in one aspect an apparatus is provided that in some embodiments is a multi-radiator panel antenna that has at least one row of discrete dual-feed crossed-dipole hybrid-coupled radiators fed by a plurality of microstrip-based power dividers, with the microstrip technology extending continuously from at least one coaxial input connector to a plurality of terminations that couple to the individual radiators. The same core design may be adapted to use for transmitting, receiving, and combined (transceiver) applications in a variety of frequency regimes, with dimensions, materials, manufacturing processes, coatings, etc., modified as required for use in each such application.

In accordance with one embodiment of the invention, an antenna panel using microstrip feed is disclosed. The panel includes a generally-vertical ground plane having a planar first face orthogonal to a principal direction of radiation of the antenna panel, and a plurality of radiators positioned in a uniform array, each radiator having four coplanar, bilaterally symmetrical, electrically closed conductive loops arranged with four-fold rotational symmetry about an axis parallel to the principal direction of radiation, each loop being supported by a support tab and being configured to function as a monopole radiator, the plane of the loops being generally parallel to the first face of the ground plane, and spaced away therefrom by a distance approximating a quarter wavelength of a frequency within an intended operational band.

The antenna panel further includes a first microstrip branch feed array, having a plurality of terminal nodes, the first array being so configured as to present a selected portion of a signal applied to an input port of the first array at each respective terminal node of the first array, and a first plurality of microstrip crossover strips, each being so configured as to extend away from the ground plane in the principal direction of radiation, each further being so configured as to couple a first portion of signal to a first loop within the radiator, to extend beyond the first loop and diagonally across a radiator, to extend back toward the ground plane, to couple a second portion of signal to a second loop orthogonal to the first loop, and to terminate in a stub.

In accordance with another embodiment of the invention, a method of directing an electromagnetic signal beam is disclosed. The method includes configuring at least one interface port to couple an electromagnetic signal for at least one of transmitting and receiving, defining a conductive ground plane having sufficient length to so function for a plurality of radiators arranged generally uniformly in a straight line along the ground plane, the radiators using crossed loop-shaped dipoles carried by support straps and electromagnetically coupled from monopole to monopole by hybrid coupler forms, the individual crossed-dipole radiators being spaced apart by a distance corresponding to a wavelength of a signal within the bandwidth of the radiators, and providing branch feed distribution of a signal between the interface port and the plurality of defined radiator locations using signal conduction between a repeatedly split and step-impedance-adjusted asymmetric microstrip-style signal transport medium and a proximal one of a plurality of walls of a chamber extending at least along the length of the straight line of the ground plane.

The method further includes coupling the signal to the radiators using extended conductors fastened to terminal nodes of the transport medium, where each extended conductor includes a face that extends the surface of one of the respective microstrips that is oriented toward the proximal chamber wall, each extended conductor passing out of the chamber through a pass aperture therein, traversing a distance parallel to a first support tab with a selected spacing, crossing over to the opposite monopole, traversing a distance parallel to a second support tab with a selected spacing, and terminating as a stub.

There have thus been outlined, rather broadly, certain embodiments of the invention in order that the detailed description thereof herein may be better understood, and in order that the present contribution to the art may be better appreciated. There are, of course, additional embodiments of the invention which will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE FIGURES

FIG. 1 is a perspective view illustrating an antenna panel assembly having a radiator array and a feed system, in accordance with an aspect of the invention.

FIG. 2 is a sectional view through an antenna panel in accordance with FIG. 1.

FIG. 3 is a perspective view showing a radiator according to an embodiment of the parent invention, along with a portion of the terminal feed arrangement.

### DETAILED DESCRIPTION

The invention will now be described with reference to the drawing figures, in which like reference numerals refer to like parts throughout. An embodiment in accordance with the present invention provides a multiple-radiator antenna that realizes beam forming according to a selected performance standard, and that provides signal distribution within the antenna using air-dielectric microstrip technology effectively to the exclusion of other transmission line technologies. In some embodiments, such an antenna can combine exceptionally low losses with inexpensive components, ease of manufacture, and desirable levels of reliability over a useful range of ordinary climate environments.

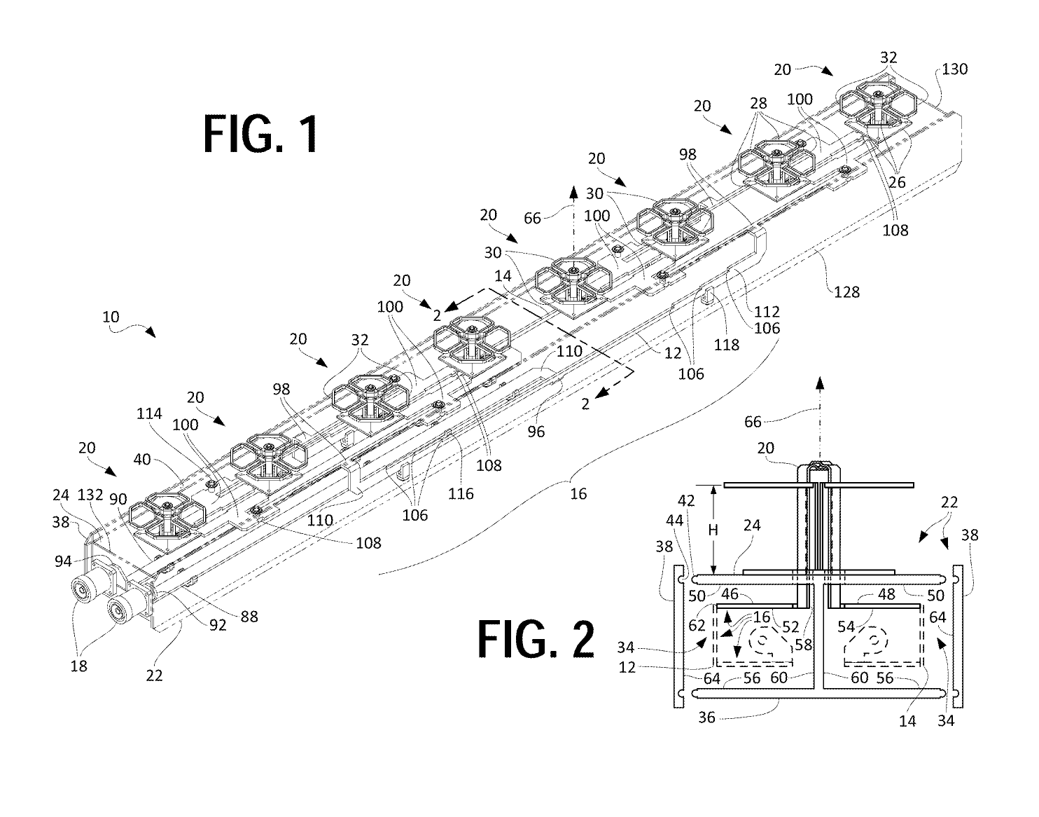

FIG. 1 is a perspective view showing a novel antenna panel 10 that is an advancement with reference to a series of crossed dipole designs developed over at least the past decade. The invention uses microstrips 12, 14 that may be configured in a corporate feed signal distribution structure 16 that may in some embodiments originate from an end locus as shown (centered and other arrangements may be used), that may use one or more feed connectors 18, presented herein as coaxial. The distribution structure 16 may route to each of a plurality of crossed-dipole loop radiators 20. The microstrip 12, 14 arrangement can beneficially lower some manufacturing and material costs compared to coaxial and even stripline structures. For example, and, by preferential recourse to air dielectric, the invention can combine low passive intermodulation (PIM) with strikingly low attenuation compared to designs that rely on solid or foamed polymer, ceramic, and other classes of dielectric material. The microstrip 12, 14 feed is discussed in greater detail below.

The invention may include a conductive enclosure 22 that can be a unitary metallic extrusion, for example, with the outer face on which the radiators 20 are mounted functioning as a ground plane 24 for the array of radiators 20. Other constructions are contemplated as well. If the radiators 20 are configured with integral conducting mounting structures 26, also discussed in greater detail below, the loop elements 28 of the radiators 20 can be economically spaced at roughly one quarter wavelength (H, FIG. 2) above the ground plane 24 with high reproducibility. This allows a direct signal portion radiated away from the ground plane 24 from the loop elements 28 that are configured as crossed dipole pairs 30, 32 to be reinforced by a reflected signal, originally the signal portion directed toward the ground plane 24, reflected back to the plane of the dipoles 30, 32 after a half-wavelength and half-cycle of travel. The time delay due to this propagation and the phase reversal due to reflection place the reflected signal in phase with the direct portion of the signal emitted a half-cycle later.

FIG. 2, a section view of FIG. 1, shows a representative internal structure for an embodiment, including an extrusion configuration that provides two separate chambers 34 for a single row of radiators 20. Where the enclosure 22 may include one or more pieces of material that may be extruded to have a combined profile selected for the purpose. As shown, the enclosure 22 can function as a robust mechanical structure, while one or more conductive-walled chambers 34 can be provided behind a radiator-side surface ground plane 24. The chambers 34 can allow the distribution structure 16 to achieve notable signal transmission efficacy and power division accuracy. Other arrangements are contemplated and are within the spirit of the invention as well. As discussed further below, the microstrips 12, 14 may each be spaced unequally from the various walls of the chambers 34. This placement may cause the microstrips 12, 14 to exhibit a nearly nominal microstrip behavior, whereas equal spacing may cause microstrip 12, 14 operation to more closely approximate that of a conventional stripline.

The conductive enclosure 22 style shown in FIG. 2 has an H-section main extrusion 36 and two closing walls 38. In the variation shown in FIG. 1, the main extrusion 36 has flanges 40 instead of the beads 42 and sockets 44 of FIG. 2. Each of the flange 40 and bead-and-socket configurations, along with others, has some advantages. The flange 40 arrangement may permit using a single H-section extrusion 36 and a single flat sheet metal closing wall 38 design that accommodates at least single-row and dual-row panels, for example, while the bead-and-socket design may reduce fastenings. Other arrangements include a single continuous extrusion into which the microstrips 12, 14 may be inserted from an end. At least some styles of flange 40 (FIG. 1) or corresponding extension of the closing wall 38 on the radiator 20 side may act as a cavity reflector, increasing gain. These and other designs may permit flanges distal to the radiators to be adapted for mounting. Further constructions are contemplated by the invention.

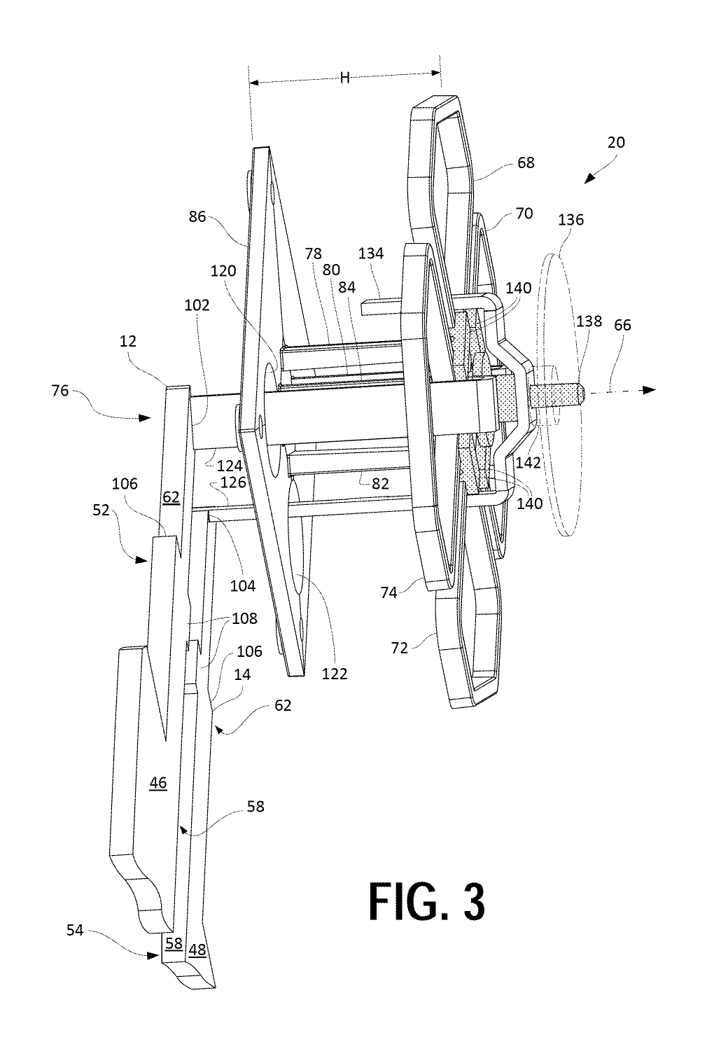

FIG. 3 is a second perspective view, showing one representative radiator 20 and the terminal nodes of two microstrip signal conductors 12, 14 as arranged within both conductive chambers 34 of the conductive enclosure 22 of FIG. 2. Positioning of the microstrips 12, 14 within the enclosure 22 may be so that the first faces 46, 48 of the microstrips 12, 14 may be positioned close to first (extruded, interior) conductive walls 50 of the chambers 34, while second faces 52, 54 of the microstrips 12, 14 may be much more distant from the second conductive faces 56 of the chambers 34. First edges 58 of the microstrips 12, 14 may have substantially uniform spacing from third walls 60 of the chambers 34. Second edges 62 of the microstrips 12, 14 may have stepwise variable spacing from the fourth interior walls 64 of the chambers 34, with the widths of the microstrips 12, 14 between the uniform-spaced edges 58 and the variable-spaced edges 62 may define a sequence of steps in impedance that may allow power level, phasing, and impedance at each radiator 20 to be set at a specific value. It is to be understood that the wall identification above may be different after each bend in the microstrips 12, 14, as best seen in FIG. 1. Faces 46 and 52 and edges 58 and 62, for example, are shown using solid lines and are labeled in FIGS. 2 and 3 for the section of the microstrips 12, 14 that terminates at the radiator 20 inputs. Faces and edges are shown dashed and unlabeled in FIG. 2 beyond the bends of the microstrips 12, 14. FIG. 1 shows that, beginning at the input connectors 18, first the bottom, then the outside, and finally the top wall (relative to the orientation of FIGS. 1 and 2) may serve in turn as the proximal wall to the first face 46 of the microstrip 12.

The spacing from each face or edge of a microstrip to the proximal chamber wall according to the instant disclosure may be consistently less than spacing suggested by traditional stripline and microstrip analysis. These smaller and in some cases irregular distances may make classical pencil-and-paper analysis non-obvious, but where ray tracing can be applied to modeling using robust software and relatively fast computers, a revised and simplified set of rules may allow initial estimates to be refined quickly with modest dimensional adjustments. These rules include the following.

First provide an application that allows a high-stiffness structure achievable by a single extrusion or welded equivalent, a set of interlocking extrusions, a welded equivalent, or the like. A plausible material may be any of a range of extrusion-compatible aluminum alloys, although a stiffer rolled alloy or other metals may be used in some applications. Some uses of the invention may call for yet other materials.

Next employ microstrip conductors, likewise made from a stiff alloy, such as rolled, cut, and formed aluminum. These may be held in place by spacers that cooperate with conductor stiffness that may make the electrical structure largely dimensionally invariant except for temperature-induced expansion, caused largely by environmental factors but including a power-dissipation component. Performance analysis by simulation may be made more rigorous by including a wide range of temperatures for each component.

Next fabricate the radiators from aluminum-clad cast zinc alloy, punched and folded aluminum alloy, or another material and fabrication process achieving similar performance. Raw zinc alloy has relatively high skin-effect penetration at the likely frequencies for antennas of the designs considered here, so that a nickel preparative coating and aluminum plating may beneficially decrease losses and provide more uniform operation. Other construction concepts may likewise realize the high performance, reliability, and low cost of those indicated.

The inventive concepts presented herein may relate to electronic systems over a broad range of frequencies, but application to microwave and near-microwave art (traditionally with a free-space wavelength shorter than 1 meter, corresponding to frequencies higher than 300 MHz) may be of particular interest as well. Frequencies of interest for typical applications may include at least cellular telephone bands, such as the GSM 900 MHz band and the 1710 MHz-2170 MHz band, as well as the reclaimed high-UHF television frequencies around 700 MHz-800 MHz, the low cellular bands around 450 MHz, satellite communications bands, etc. The concept as taught herein may be scalable over a wide range, so that significantly higher and lower frequencies than these may likewise be considered, with radiator and backplane adjusted in size to realize performance levels comparable to those already simulated and prototype tested. It is to be understood that lower frequencies do not bar use of the concepts except insofar as manufacturing costs for the very large components needed for lower frequencies may become greater, and that limitations at higher frequencies relate to dimensions of components with respect to voltage withstand at power levels high enough to be useful. At frequencies significantly higher than present cellular telephone ranges, related art currently uses circuit-board methods and materials in building numerically large two-dimensional arrays of low-power components. While miniaturization may make manufacturing of low-loss air-dielectric antennas more difficult, it is anticipated that there may be considerable overlap between the various antenna arts.

In some embodiments, a user may elect that all power levels, signal phase values, and impedances to be found at the respective radiators be identical to one another. Assuming ideal radiators, this may provide a beam perpendicular to the ground plane 24, with each radiator 20 emitting a so-called skull pattern, and with the patterns, as detected at far field, effectively superimposed. Net antenna gain at each azimuth in such embodiments can be approximated by multiplying the (voltage) gain of a single radiator by the number of radiators. To the extent that the radiators 20 themselves are not ideal, a beam so formed may exhibit so-called “squint,” i.e., may have a beam not concentric with the radiator's axis of rotational symmetry 66. The superposition of the beams may likewise be non-ideal, reducing far-field gain from nominal. Although squint is not further addressed in the presentation that follows, existence of such artifacts may be assumed, modeled, tested, and compensated for in practice.

At least in non-orthogonal embodiments, phasing and impedance may have fixed values, and power levels may be made unequal according to a plan that causes the beam to be non-uniform in elevation and directed (tilted) below the horizon toward which the array 10 is directed (this applies to terrestrial broadcasting; for aircraft communication and applications that call for different patterns, other power distribution plans may be developed using similar approaches). Similarly, assigning different phasing to each radiator 20 according to some plans may allow a tilt comparable to that of a varied-power embodiment. For either of these, beam shape may be symmetric about a nominal elevation angle to a greater or lesser extent. Altering the third variable above, i.e., assigning different impedances to different power distribution output ports may be also feasible, although requiring corresponding (non-uniform) input port impedances to the radiators 20 to limit return losses. In addition to the above realizations of beam direction, an entire panel array 10 can be tilted to direct a uniform (perpendicular to the ground plane 24) beam. These methods may be combined, although not all can interoperate equally well in shaping gain (transmitted signal strength, received signal sensitivity) over an area.

Continuing with FIG. 3, the crossed dipole radiator 20 may at least in its feed design and in fabrication be formed as a single unit. The fabrication process may be, for example, casting, forging, sintering, or pressing, formation by steps of punching and folding of sheet metal, etc. Each of the four loops 68, 70, 72, 74 may be a monopole supported at the loops' common proximal locus 76 by a respective conductive flat tab 78, 80, 82, 84 roughly a quarter wavelength (dimension H) long, so that the integral base 86 and the ground plane 24 (FIGS. 1 and 2) to which the base 86 attaches appear electrically as an open circuit to the loops 68, 70, 72, 74. Each of the flat tabs 78, 80, 82, 84 may function as one component of a microstrip, and, as in other microstrip designs, may be understood to possibly act as one of two facing walls of a short segment of waveguide having open sidewalls.

As shown in FIG. 1, the signal distribution strategy for the two inputs to each radiator 20 may use two separate input feeds 88, 90 from input attachment points 92, 94 of the two microstrips 12, 14. Each microstrip 12, 14 may be split as needed using tee junctions 96, 98, 100 (also termed tee split points herein), that may apply a portion of its signal energy to each radiator 20. Returning to FIG. 3, each microstrip 12, 14, after successive divisions, may terminate at one of two terminal nodes that may function as the inputs 102, 104 to each respective radiator 20. Distances between tee split points 96, 98, 100 for all microstrip segments may be selected to determine propagation timing, while step changes 106 in widths of the segments and lump impedance elements 108 may define impedances before and after the respective splits, and thus may contribute to defining power division at each split. Impedance-change steps 106 and lumps 108 may affect signal phase, so step size and placement may also be factors controlling relative timing of the respective radiator output signals. Likewise, each change in dimensions can alter transfer function characteristics of the microstrips 12, 14, so it may be preferred to make each signal path branch substantially identical to the others in order to minimize differences in signal content of the energy applied to each (effectively identical) radiator 20. Where nonuniform power distribution or phasing is desired, dimensions may be fixed at different values to accommodate such purposes. Thus, dimensions of the microstrips 12, 14 may be likely to be factors affecting properties such as beam tilt.

The embodiment shown may use corporate (also termed branch) feed, with the input signal being split repeatedly and each radiator preferably receiving a portion of the signal energy on the same cycle of the waveform, within a phase range determined by spacing of splits, size of impedance steps, etc. In some microstrip embodiments, other feed methods may be used, such as traveling wave (TW) feed, wherein a single pair of feed lines (in a dual-input embodiment) may traverse all radiators in succession, with a portion of the signal energy in the feed lines coupled to the dipoles of each radiator. With judiciously selected dimensions for power coupling and signal phasing, TW couplers can tap off substantially all of the input power before reaching a terminal load, and the timing and strength of each output can be set according to a selected scheme. It is to be understood that in the particular case of TW feed, each successive radiator may receive its input one cycle later than the radiator next closer to the source, a phenomenon having negligible deleterious effect for many applications. Extending this concept, half-wave, double-wave, and other spacings of radiators and feed lines can produce comparable results if considerations peculiar to each such spacing, such as grating lobes, may be accommodated.

Branch feed lines may be readily analyzed and simulated using commercial stripline and microstrip analysis software. The same analysis and simulation software can include flat tabs and input feeds found in terminal portions of circuits used in embodiments of the invention. A microstrip 12 branch feed power tee divider 96, 98, 100 may be placed asymmetrically in a chamber 34 that may be effectively grounded on all walls 50, 56, 60, 64. That is, a first face 46 of the microstrip 12 is positioned proximal to a first wall 50 of the chamber 34 at a roughly uniform first face distance, a first edge 58 of the microstrip 12 may be continuous and may be positioned at a roughly continuous first edge distance from a second chamber wall 60, a second face 52 of the microstrip 12 may be positioned at a roughly uniform second face distance from a third chamber wall 56, and the second edge 62 of the microstrip 12 may be stepped as required for impedance transformation and consequently may be positioned with nonuniform spacing with respect to the fourth chamber wall 64. The microstrip 12 may not be spaced five times its width from the second and fourth chamber walls 60, 64 as dictated by conventional practice in the microstrip and stripline art, so computer modeling of the interaction of the surfaces may be advisable. Similarly, the spacing between the first microstrip face 46 and the first chamber wall 50 may be sufficiently closer than the spacing between the second microstrip face 52 and the third chamber wall 56 that the term microstrip may be appropriate with respect to at least the first face 46, with a much larger part of the transmission line energy found in the waveguide-like region located between the first face 46 and the first wall 50 than in the region between the second face 52 and the third wall 56.

The chamber 34 in some embodiments may be arranged with a partition that incompletely splits it along its longitudinal axis into at least two longitudinal sub-chambers. The power divider in such embodiments may be located in part on each side of the partition, with one or more links across the partition between parts of the divider. This arrangement may beneficially serve to provide sufficient microstrip-to-wall surface for dividing the signal power effectively while keeping artifacts such as crosstalk and PIM at low levels. Other embodiments may use a single chamber, may include transverse instead of longitudinal partitions, may have partitions extending entirely across the chamber with feed lines coupling signal power through the partitions at required locations, etc.

Consistent with chamber profile and space constraints, the microstrip 12 may be formed and folded in such a way that a first portion 110 may be proximal to a wall—in the embodiment in the drawings, the third wall 56 of FIG. 2 may be proximal to the first face 46 over the first microstrip portion, also termed the first feed 88, as shown in FIG. 1. After a flat or in-plane right-angle turn 110 and a first so-called easy way bend as shown in FIG. 1 (the latter immediately precedes the first tee junction 96), the first face 46 may be proximal to a different wall, the fourth wall 64 as shown in FIG. 2. The signal path in some embodiments may be momentarily transverse to the long axis of the chamber. A second microstrip portion 112 may again have a flat turn 110 and an easy way bend (preceding a tee junction 98), resulting in the first face 46 being proximal to yet another wall, the first wall 64 in the embodiment shown in FIG. 2. In each instance shown, the tee junction 96, 98 redirects the microstrip 12 to continue proximal to the new wall, once again propagating the signal parallel to the longitudinal axis of the chamber 34 and the first portion 110 of the microstrip 12. This arrangement may allow the signal path for the power divider to approximate one over a flat ground plane, with added benefits of reducing total enclosed volume and placing the microstrip 12 within a protective housing 22. With consideration as to layout, this arrangement can also place all inputs and outputs on preferred faces of the housing 22.

In many embodiments incorporating the inventive apparatus, microstrip 12 positioning may require standoff fittings 114, 116, 118 to maintain a substantially fixed spacing between the surfaces of the microstrip 12 and the chamber walls, as well as controlled positioning of the feed tabs with respect to the loop radiator support strips, discussed below. Such standoff fittings 114, 116, 118 can be implemented in a variety of shapes, as shown in FIG. 1, as well as technologies. Regarding technology options, low-density foamed dielectric blocks that partially fill the volume of the chamber at one or a plurality of locations along its length can be fitted around the microstrip power divider before the divider may be inserted into a one-piece extruded chamber from an end. Smaller fittings having greater stiffness can be clipped around the microstrip 12, as represented by one type 116, or clipped into holes in it, as represented by another type 114; it may be preferred to arrange any such holes to introduce minimal effect on propagation characteristics. Fittings made of such materials as low-dielectric-constant polymers may be preferred in some applications, while ceramics and other classes of materials may have benefits such as mechanical strength or stability that can outweigh their typically higher dielectric constants, loss tangents, conductivity, etc.

Other stabilization styles may also be successfully applied, such as metallic-conductor quarter-wave standoffs. While somewhat more frequency-sensitive than fittings using dielectric insulators, shorted stubs can perform filtering and phase adjusting functions as well as providing mechanical stability.

Returning to FIG. 2, in some embodiments, a multiple-piece housing/chamber extrusion may be used, wherein a first piece has a continuous H-section profile 36. Apertures 120, 122 for respective feeds 124, 126 of a single row of radiators 20 are shown in FIG. 3. These may align with corresponding apertures in one leg of the H-section 36 but may be on opposite sides of the leg-connecting web having faces 60. Attachment hardware may be placed as needed. An H-section profile may simplify assembly. Definition of the housing 22 as an enclosure, exclusive of end walls, may be realized with a second and different extrusion 38, having features such as an extrusion section profile element that interlocks with the terminal edge elements of the H-section extrusion to improve weather protection, a directing flange 40 may be included on the radiator side to direct emission in part, one or more mounting flanges 128 on the side opposite the radiator, profile elements may be included for attachment to a second H-section extrusion, some combination of such fittings, etc. A complete housing may also include extrusion section cutoff plane top 130 and bottom 132 end closure fittings perpendicular to both the ground plane face 24 and the side wall faces 38. Such end fittings 130, 132 may provide sealing or venting, may be metallic or polymer, etc., as determined by the user for a specific application. In the embodiment of FIG. 1, the bottom end fitting 132 may mount the input connectors 18; in other embodiments, connector 18 placement and number may differ.

To the extent that disassembly for repair may be impractical for some configurations of antenna panels incorporating aspects of the inventive concepts disclosed herein, permanent fixing of standoffs and/or the power divider microstrips to the inside of the chambers may be preferred in some embodiments. Examples of attachment provisions (permanent or otherwise) may include adhesives that bond standoffs to housing/chamber walls, metallurgical bonding of standoffs to chamber walls, etc. Metallurgical bonding methods may include providing dielectric standoffs to which joining plates may be affixed, then providing joining ports through the extrusion and soldering or brazing the plates into place; spot welding the plates, etc. Conductive standoffs may be fixed similarly. Adhesives may be applied to standoff surfaces prior to assembly in order to permit attachment may afterward be activated chemically, mechanically, thermally, by scintillating or other radiation, or by other means. Such attachment processes may be reversible in some embodiments. Where welding or similar joining methods may be used, modeling and simulation may consider possible reflection, reradiation, PIM, etc., by added or deformed conductive materials.

Some approaches—i.e., arrays of relatively low-power radiators driven generally in parallel to form high-gain directional beams—may employ either a separate feed line from a power divider to each radiator input node or a TW equivalent. Largely with a view to economy. A small diameter polymer-dielectric coaxial cable may interconnect the divider and the radiating elements. Such cable can have drawbacks. For example, solid or foamed polymer dielectric used in coaxial cables, twin lead cables, striplines, and microstrips consistently introduces higher losses than equivalent conductor arrangements using air dielectric. Also, for a given construction and material choice, coax losses generally increase as diameter decreases.

Coax effectively may serve as its own high-uniformity shield, so that it contains signal energy more effectively than microstrip and stripline. All things being equal, dielectric-filled coax may have lower loss (and higher propagation velocity) than comparable stripline, with similar microstrip somewhat more lossy than stripline. For air-filled equivalents, attenuation may be significantly lower and velocity may be appreciably higher, which introduces a tradeoff. Using stripline or microstrip, despite its possible lossy signal transmission, can keep total price and manufacturing complexity low, even though one or more of transmitter power, receiver gain, filter complexity, and antenna element count for a specific level of performance may increase. It is submitted that contemporary practice has failed to fully evaluate and develop a category of apparatus, namely air-dielectric microstrip. The present application is the first that provides a fully realized microstrip-feed panel in conjunction with a one- or two-dimensional array of low-cross-coupling, low-mutual-coupling crossed-dipole radiators having polarization determined by feed phase.

FIG. 1 shows such a device. Where a single circularly polarized output beam (i.e., the special case within the category of elliptical polarization wherein e- and h-magnitude may be constant, so that the axial ratio may be equal to 1.0) is to be approximated, and the feed structures within the panel to the two sets of dipoles 30, 32 in a single row of radiators 20 may be closely matched electrically, a user can apply equal signal waveforms of equal power and a 90 degree difference in phase to the respective panel input ports 18. Relative signal timing between two otherwise equal inputs driving orthogonal radiators largely may define the axial ratio of the far-field beam. Synchronous-phase input signals typically may produce a single vertically-polarized beam, while a fixed 180 degree phase difference between inputs may give a single horizontally-polarized beam—i.e., axial ratio may be zero in both cases. In some embodiments, external signal paths from a signal source to two matched input ports 18 can be arranged to differ by 90 degrees instead of being the same or opposite; this may allow synchronous-phase signals from a source to be used to realize a circularly polarized beam. Relative input phase setting for such embodiments may use differing-length feed lines, for example, or may use a Magic Tee or other apparatus that inherently or by design may generate two outputs that differ in phase by a selected amount, the latter permitting equal-length feed lines to be used. In other embodiments, a single signal source can feed both panel inputs 18, using a signal splitter proximal to or integrated into the power divider. Such a signal splitter may use the aforementioned Magic Tee or another device to control signal phase to the power divider signal paths.

If a first signal is applied to one of the panel input ports 18 and a second signal to the other, where the signals may be uncorrelated but on the same channel, then beams formed by the emission of these signals may remain separate and have polarization axes of 45 degrees positive and 45 degrees negative, respectively, until mixed by reflections, which may cause each signal to appear as a noise component in the other. Feed to each input 18 may instead include energy combining two uncorrelated signals in the same channel. Each signal may be phased to create circular/elliptical polarization by setting phase delay to the respective inputs for a first one of the signals to be opposite in sign to phase delay to the respective inputs for the second signal. A beam formed by a panel 10 so fed may contain two elliptically polarized signals of the same frequency but opposite handedness. If the two instances of each signal are generally orthogonal in phase and generally equal in magnitude, then the polarization may approach circular for each. The relative magnitudes of such left- and right-hand polarized signals can be independent.

Single-channel programs, multiple frequency-hopping and/or time-domain multiplexed band-sharing signals over a band, broad-spectrum multiple-channel transmissions, and other applications can be suitable for antennas according to at least some of the embodiments of the invention, limited by the achieved bandwidth of each complete configuration. Allowable applied and radiated panel power levels may be determined by aperture (panel height), the number of independent radiators operating together, material selection, and heat dissipation due to losses, as well as by regulations. Increased radiator loop 28 material thickness may lower Q, i.e., can broaden an antenna's working frequency range. This may also increase reflective losses at all frequencies, i.e., increasing the lowest (best) value of VSWR. Incorporating a plurality of concentric loops may realize a wider usable bandwidth than a similar single loop, but may have a plurality of lowest −VSWR frequency ranges separated by at least one intermediate range with higher VSWR.

FIG. 3 shows a single radiator. The respective feed tabs 124, 126 may serve as terminal extensions of the terminal nodes/inputs 102, 104 of the microstrips 12, 14. In at least some embodiments, the feed tabs 124, 126 can be separate components joined to the terminal nodes/inputs 102, 104, a process that may permit the microstrips 12, 14 to be inserted from one end into respective closed chambers 34 within an extrusion, such as a unitary extrusion (combining extrusions 24, 38 of FIG. 2) prior to feed tab 124, 126 attachment. In some embodiments, the feed tabs 124, 126 may be soldered to aluminum microstrips 12, 14 using tin-zinc or other alloy solders, brazed using aluminum-silicon filler metals, etc. These processes may provide effective electrical and mechanical bonds and result in less thermal stress and temper loss, as well as simpler equipment, than filler metal, spot, or vibration welding, better reliability than riveting, and less labor than screws, although each of the latter and other fastening methods may be selected.

With alternative ground plane configurations, such as an open-backed extruded section, a ground plane fabricated from multiple parts, a ground plane assembled as a series of laterally-mated pieces, the H-configuration described below, etc., may be employed in place of a unitary extrusion having multiple internal chambers, a group of feed tabs 124 and an associated microstrip 12 can be a single unit. This potentially may allow the power division and distribution microstrip 12 to be made by a single cutting step and one or more forming steps, avoiding soldering or other fastening steps that can increase production cost and add to any risk of introducing PIM source locations.

In either configuration, the feed tabs 124, 126 may pass through clearance holes in the panel 24, and may further pass through holes 120, 122 in the base of each radiator 20, then may rise parallel to respective first supporting flat tabs 84, 82, cross above the respective first monopoles 74, 72, may descend along respective second supporting flat tabs 80, 78, and may terminate at a specified distance along the second tabs 80, 78. Where needed for stability, spacing between the riser strips 124, 126 and the flat tabs 84, 82 may be controlled by insulating structural elements 138 in clip or other form, preferably physically small and having a low effective value of dielectric constant so that their influence on electrical performance of the antenna may be kept low. Any clips selected for use may attach to the radiators 20 and/or the feed tabs 124, 126 and may use detents or holes in the conductive elements, may wrap around the parts to any selected extent, may be retained using adhesive, etc., as selected for an embodiment. Setting and/or foaming polymers—in effect, blobs of material—may be used in place of clips. FIG. 3 also shows standoffs 140 between loops 68, 70, 72, 74 that may be utilized with the invention.

Considering the portion of a microstrip 14 proximal to each radiator 20, each feed tab 126 in conjunction with its respective flat tab 82 may form a first hybrid coupler that may transfer a first portion of its signal energy to a first monopole 72. In conjunction with a second respective flat tab 78, the terminal stub 134 of the feed tab 126 may form a second hybrid coupler that may transfer a second portion of its signal energy to a second monopole 68. The two monopoles 72, 68 may operate jointly as a dipole. Since low loss may be associated with high coupling efficiency, riser strip to monopole interface design may be improved by precise initial simulation. While rising alongside a first flat tab 82, a feed tab 126 may act first as a microstrip parallel to a ground reference, then may form a coupler that may transfer signal energy to a core-proximal portion of a loop 74 that may include a perimeter length of approximately a half wavelength. Passing beyond this loop 74, the microstrip 126 may traverse an approximation of free space for a distance of approximately a half wavelength, then may form a second hybrid configured to terminate in a tuned stub 134 alongside a second flat tab 78. The effect of an arrangement with accurately selected dimensions may be to couple the largest portion of the remaining signal energy into the second loop 68. In such a construction, any remaining signal energy may be reflected off the termination impedance of the stub arriving back at the first loop 72 in phase with the next cycle of signal energy arriving from the input. Thoughtful layout and simulation can provide an operational design with minimal experimentation. Radiator configuration using crossed pairs of loop-shaped dipoles is an advancement. The concept may be substantially free of cross-coupling and other artifacts. Disk-shaped parasitic elements 136 may be added at will, preferably aligned with each radiator's beam axis 66 and may be isolated using standoffs 142, and can alter radiator gain largely independently of polarization. A typical parasitic may be ¼ wavelength in diameter for some frequency in the pass band, and may have diameter, thickness, conductivity, and spacing selected according to simulated and tested performance. Multiple parasitics on each radiator may further enhance performance, but typically exhibit diminishing benefit.

In some embodiments, a single input port may be used in place of the dual ports 18 shown. In a simpler embodiment, the second microstrip may not be installed, and the second dipole in each radiator may be unused, which may result in a 45 degree slanted signal polarization. In another embodiment, an internal power splitter may drive a second microstrip with a zero or 180 degree delay, which may provide a linearly polarized signal, with a 90 degree delay, providing circular polarization, or with an intermediate phase delay that may provide elliptical (non-circular) polarization.

Circular polarization may serve linearly polarized receiving antennas at any orientation, albeit with 3 dB less signal than circularly polarized receiving antennas would achieve, while allowing circularly polarized receiving antennas with like polarization to reject reflections. In receiver and transceiver applications, circularly polarized configurations can receive linearly polarized signals, with the received signal strength largely independent of remote antenna orientation. Embodiments may have a single row of radiators, or two or more rows. Where two rows may be used, the second row may duplicate the signals of the first row or carry signals unrelated to those of the first row. Where the signals are duplicated, the remaining input nodes 18 may be driven separately, or with the same single connector and two more feed lines within the housing 22 and may provide a single linearly or circularly polarized transmitted signal. Rows that may be parallel and staggered may show lower mutual- and cross-coupling than those with other relative positioning.

The radiators 20 are described above as being manufactured from any of a variety of materials as preferred for an application. One example is the range of common zinc-manganese alloys, which may be quite inexpensive and easy to work with—for example, they use of inexpensive material that may be readily cast using molds that are uncomplicated and durable. While the intrinsic conductivity of these alloys may be low compared to copper, silver, or aluminum, applications that use low or moderate power levels may be essentially unaffected by this attribute. The alloys also may accept plating readily, so platings or other coatings in various metals, inherently thicker than skin depth at the frequencies contemplated for these devices, may allow such radiators 20 to have electrical performance approximating that of solid copper or aluminum equivalents.

The radiators 20 may likewise be fabricated from nonconducting or semiconducting materials that accept metallization, as dictated by cost, durability, and suitability to mass-production assembly. In one instance, the radiators 20 and the enclosure or housing 22 may be manufactured from fiber-filled and foamed polymer material, and then plated. If the polymer readily accepts assembly by a method such as gluing or plastic welding, has sufficient ability to withstand weather extremes, and may be stable and not self-heating in response to radio signals at power levels of interest, then a virtually all-plastic antenna panel 10 may be provided. Such an implementation may transmit and/or receive using only a layer of plating over a “plastic” structure to carry the signals, including the microstrips 12, 14, which still may have the properties of air dielectric waveguides when signals are carried between continuous surface plating on the microstrips 12, 14 and the enclosure 22 inner wall. Carbon fiber and nanotube materials as structure and/or filler can be robust and somewhat conductive, and may be used to advantage, even if more costly than zinc alloy. In practice, since the surface, whether plated or not, necessarily may function as the signal conductor in VHF and higher bands, any candidate material requires an adequately smooth surface finish. Particularly where recovery for reuse may be infeasible, a “plastic” antenna may be usable for short-duration tasks, even if such a device is not suited for long service. If materials and labor are sufficiently inexpensive, such a device may be disposable or recyclable.

As noted, signals reaching the ends of the microstrips 12, 14 may be further coupled by feed strips 124, 126, preferably with close control of dimensions and thus with scant signal reflection at the transition. The feed strips 124, 126 carrying signals from the microstrips 12, 14 may be parallel to support flat tabs 78, 80, 82, 84, with a selected width and spacing. These dimensions may be viewed as permitting propagation of applied signal power substantially as does a waveguide—that is, any signal above cutoff as defined by the chamber 34 width propagates more readily. The spacing in embodiments of the invention between a microstrip face 46 and the proximal chamber wall 50, etc., and their extensions, the feed tabs 124, etc., may strongly affect impedance, while suitability for carrying particular propagation modes, such as TE₁₀ mode, may be affected by chamber 34 width, along with microstrip 46 width, at each point during propagation. The edge walls of a classic waveguide operating in the dominant mode TE₁₀ may be uniformly electrically null, serving to provide greater structural integrity, air seal, and a barrier against electrical leakage. For this reason, waveguide-type walls may be omitted where not needed, as in some embodiments of the invention, leaving the chamber 34, the microstrips 12, 14, the feed strips 124, 126 and the support flat tabs 78, 80, 82, 84 to define a signal propagation path.

The signal paths may effectively turn, at the microstrip termini 102, 104, from a route that may be uniformly spaced away from a chamber 34 wall—specifically, from the inner housing surfaces 50 that may be the other side of the external ground plane 24 on which the radiators 20 may be mounted—to a route orthogonal to that surface 50. The feed tabs 124, 126 may be soldered or otherwise attached to the microstrips 12, 14 at the latters' termini 102, 104. The feed tabs 124, 126 may exit the chamber 34, with proximal faces of the feed tabs 124, 126 and the support flat tabs 78, 80, 82, 84 may be parallel. Spacing between the feed tabs 124, 126 and the support flat tabs 78, 80, 82, 84 may be substantially the same as spacing between the microstrips 12, 14 and the proximal chamber wall 50, etc., over the part of the path within the enclosure 22. Spacing may be adjusted as required to control impedance and insert additional reactive terms.

The support flat tabs 78, 80, 82, 84 may be at ground potential at the ground plane 24 and may extend perpendicularly thereto in an approximation of the beam direction 66. The support flat tabs 78, 80, 82, 84 may terminate ¼ wavelength distal to the ground plane 24, with the support flat tab termination possibly having the form of a tee from which two conductors extend at right angles to one another, then may turn within a plane parallel to the ground plane 24 and may join to define monopole loops 68, 70, 72, 74. The quarter-wave spacing may substantially isolate the loops 68, 70, 72, 74 from the ground plane 24. An associated feed tab 126 may cross over from the first support flat tab 82 to a second support flat tab 78 with a specified conductor length, then may pass along the second support flat tab 78 and may terminate as a stub 134 in the feed tab's characteristic impedance. The second support flat tab 78 may begin at the radiator base 86 (proximal to the ground plane 24) and may terminate ¼ wavelength away in a tee that itself may begin a second monopole loop 68. Signal coupling from the stub-terminated feed tab 126 to each of the first and second support flat tabs 82, 78 and from the respective support flat tabs 82, 78 to the first and second monopole loops 72, 68 may be a function of the physical dimensions of the feed tab 126 and the stub termination 134, as well as the physical dimensions of the respective support flat tabs 82, 78 and the impedance associated with the spacings between the feed tab 126 and the support flat tab 82 and between the stub termination 134 and the support flat tab 78.

A propagation time for traverse of the distal crossover portion 144 of one of the feed tabs 126 may give the signal applied to the two monopoles 72, 68 driven by that feed tab 126 opposite phase at each moment in time. A consequence of this may be that the monopoles 72, 68 may function jointly as a first dipole.

The configuration of the instant invention may result in application of a drive signal to both monopoles 72, 68 of a pair 30 (refer to FIG. 1), with reference to the geometric center of the pair 30, at an axis of rotational symmetry 66, with signals that may have opposite phase. Effects of the latter configuration include driving the respective monopoles 72, 68 with largely symmetrical excitation energy levels. This establishes an intended low level of cross coupling between the two crossed dipoles 30, 32 of each radiator 20, and may reduce mutual coupling between proximal radiators 20 on a common array 10.

Considering next the proximal feed tab 124—that is, the drive element feeding the two monopoles of the second dipole 32 in each radiator 20—the function of the proximal feed tab 124 may be substantially the same as that of the proximal feed tab 126, except that it may pass between the distal feed tab 126 and the loop elements 28. In at least some embodiments, the propagation path for the signal carried by the proximal and distal feed tabs 124, 126 may be somewhat unequal. Dimensions for the feed tabs 124, 126 can be selected by user preference. In embodiments wherein the feed tabs 124, 126 may be respectively shorter and longer than an optimum length, respective feed timings may be slightly different from, although close to, an ideal half-wavelength. This provides an approximation of a nominal beam pattern. In at least the embodiments shown in FIGS. 1-3, the shape of each of the feed tabs 124, 126 may be made slightly circuitous by a series of bends that cause the signal path lengths, and thus the phasing, to be very nearly equal, obviating potential phase error.

Interaction between the two feed tabs 124, 126 may remain small, at least by virtue of the tabs' signal paths being substantially orthogonal. That is, any signal coupled from one of the tabs into the other may induce a current at right angles to the direction of signal propagation for the other, resulting in a slight back EMF in the first tab due to the presence of the second, and vice versa, but little else.

The presence of the “other” tab may be measurable as an impedance lump in each, although more pronounced in the distal feed tab 126. This is because the signal may be present largely as a field between the proximal feed tab 124 and its associated support tabs 84, 82, and between the distal feed tab 126 and its associated support tabs 82, 78. The signal intended to propagate on the proximal feed tab 124 may be oriented away from the distal feed tab 126, while the signal intended to propagate on the distal feed tab 126 may be present largely on the face directed toward the proximal feed tab 124. As a result, the signal on the distal feed tab 126 may be somewhat more susceptible to interaction with the other strip than is the signal on the proximal feed tab 124. Overall, however, signal coupling into each strip from the other may be slight.

It may be possible to cause the realized beam direction in embodiments of the invention taught herein to approximate a nominal beam direction using basic dimensions—that is, values for dimensions that may closely follow arbitrary center frequencies, ideal propagation rates, simplified assumptions about interaction of dielectric lumps, etc. Slight variations of the basic dimensions, however, can be applied in such a way as to provide a realized beam direction that yet more closely approximates a nominal beam direction. As noted above, one such variation makes the feed strip propagation path lengths almost exactly the same. This can be further enhanced by causing whichever of the two paths may be shorter to be the one that has greater capacitive phase delay, for example, so that phase difference due to difference in physical length compensates in part for reactively-sourced phase difference. Similarly, since some embodiments of the radiators 20 may include a single pair of pass holes 120, 122, selected dimensions of such radiators 20, such as support tab width, loop perimeter, etc., may be made slightly asymmetrical, with the radiator 20 pass holes 120, 122 providing positive keying to ensure that such asymmetry may be uniformly applied and compensates for any demonstrated tendency for a fully symmetric radiator 20 to output an asymmetric signal. Similar keying may be possible for punched-and-bent or otherwise fabricated radiators. Optimization of dimensions may be preferably realized by inputting accurate initial dimensions into simulation software and analyzing the effect of small changes until a solution within a practical range is reached.

Adjacent portions of each two loops 28 may be parallel, may have generally matching facing surface widths, and may be spaced apart with a separation selected to form a hybrid coupler. Each facing surface has a physical length on the order of a tenth of a wavelength for a frequency in the working range for which the radiator 20 may be intended. Dimensions for achieving a particular radiative efficacy goal at a given center frequency and bandwidth may be best verified through simulation and prototype testing, including balancing these dimensions with loop height H above the ground plane 24, loop circumference, and other dimensions.

The practitioner may be able to establish a second usable band for a given radiator size. The perimeter shape for each loop 28 may be square or non-square, but is preferably convex. The characteristic curvilinear perimeter shape of the loops shown herein is not mandatory, but may prove beneficial in minimizing PIM distortion of received signals in the presence of transmitted signals that may be over 100 dB greater in magnitude and located with 5% in frequency. The loops 28 need not necessarily be formed of continuous conductors if one or more additional capacitive or hybrid segments in combination with conductors establish a continuous signal path. Extensive testing has demonstrated, however, that using other shapes, such as the radial straight-line (non-hybrid) monopoles or ring-shaped loops as in some antennas, may severely degrade the ability of each radiator to support low cross coupling between the dipoles formed by loops 28 in the instant invention. Such other (non-hybrid) shapes may also inhibit realizing low mutual coupling between dipoles in proximal but separate radiators. Some designs may render impedance matching in arrays of uniformly-distributed crossed dipoles, such as single-row arrays, two-row staggered arrays, and others essentially infeasible.

A radome may be included in order to enclose the antenna panel radiators, largely for weather protection, but additionally to conceal the radiators from view and for other purposes selected by a user. A single extruded, bent, or vacuum formed sheet of polymer or other material selected for its dielectric properties can freely pass radiation to and/or from the panel while blocking rain and contaminants from the radiators and the feed system. Including a radome may allow the feed strip pass holes to be left open, for example, rather than requiring an individual barrier plug in each. A radome may also guard the individual feed strips and any dielectric support fittings used to stabilize them from being damaged by impacts of wind-blown objects, animal contact, etc. Top and bottom elements of a radome may be integral with side walls and a single surface through which most radiation passes, or may be separate parts. Since the top, bottom, and side walls may be not major factors in propagation, any of these may be conductive, either integral with or separate from the ground plane. In embodiments wherein any of these may be conductive, the conductive component may affect beam elevation. The radome may be vacuum-formed or bent from sheet stock, extruded, or otherwise put into a shape meeting operational requirements. While simple and concealing enclosure shapes may be common in panel antenna practice, some embodiments may incorporate a plurality of more-conformal radome shapes or separate radomes for individual radiators or groups of radiators. Conductive, resilient, or other forms of closures may be affixed to the top and bottom openings of the chambers behind the ground plane front surface. Downward-facing radome and chamber openings may be completely uncovered or have covers that include open vents in some embodiments not requiring pressurization.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

We claim:

1. An antenna panel, comprising:
a ground plane having a first face orthogonal to a principal direction of radiation of the antenna panel;
a plurality of radiators positioned, each radiator having coplanar, bilaterally symmetrical, electrically closed conductive loops arranged with rotational symmetry about an axis parallel to the principal direction of radiation, each loop being configured to function as a monopole radiator, the plane of the loops being generally parallel to the first face of the ground plane, and spaced away therefrom;
a first microstrip branch feed array, having a plurality of terminal nodes, the first array configured to present a selected portion of a signal applied to an input port of the first array at each respective terminal node of the first array; and
a first plurality of microstrip crossover strips, each configured to extend away from the ground plane in the principal direction of radiation, each further configured as to couple a first portion of signal to a first loop within the radiator, to extend beyond the first loop and diagonally across a radiator, to extend back toward the ground plane, to couple a second portion of signal to a second loop orthogonal to the first loop.

2. The antenna panel of claim 1, wherein the ground plane further comprises:
a second wall of the ground plane distal to and generally parallel to the first wall thereof; and
a chamber integral with the second wall.

3. The antenna panel of claim 2, wherein the ground plane further comprises a plurality of chambers.

4. The antenna panel of claim 2, wherein the at least one microstrip branch feed array is contained at least in part within the chamber.

5. The antenna panel of claim 1, wherein the ground plane further comprises a plurality of penetrations, each passing one of a terminal element of the microstrip array or a component configured as an extension thereof.

6. The antenna panel of claim 1, wherein each of the plurality of radiators further comprises a unitary conductive surface conductively joined to the ground plane.

7. The antenna panel of claim 1, wherein each terminal node of the microstrip further includes an attachment point configured to join to a crossover strip by one of soldering, brazing, welding, crimping, or attachment using a separate fastener.

8. The antenna panel of claim 1, further comprising:
a second microstrip branch feed array having a plurality of terminal nodes, the second array configured to present a selected portion of a signal applied to an input port of the second array at each respective terminal node of the second array; and
a second plurality of microstrip crossover strips, each configured to extend away from the ground plane in the principal direction of radiation, each further configured to couple a first portion of signal to a third loop within the radiator, to extend beyond the third loop and diagonally across a radiator associated with the first microstrip branch feed array, to extend back toward the ground plane, to couple a second portion of signal to a fourth loop orthogonal to the third loop, and to terminate in a stub.

9. The antenna panel of claim 1, wherein each of the plurality of radiators further comprises:
a first loop having two substantially orthogonal straight segments and a perimeter whereof the length approximates a half wavelength of a frequency within a band over which the antenna is operational, a junction locus between the straight segments being proximal to the center of rotational symmetry of the radiator;
a second loop orthogonal to the first loop, and substantially identical thereto;
a third loop and a fourth loop, each substantially identical to the first loop, the third and fourth loops each having a straight segment parallel to a straight segment of each of the first and second loops.

10. The antenna panel of claim 1, wherein each support tab is located at a junction locus between the straight segments of a loop, is conductive, and extends from the ground plane to the junction locus.

11. The antenna panel of claim 1, wherein each support tab is substantially planar along a face directed toward a centroid of a loop supported by the respective support tab.

12. The antenna panel of claim 2, further comprising at least one dielectric spacer configured to stabilize positioning of the first microstrip branch feed array with respect to at least one wall of the chamber.

13. The antenna panel of claim 2, further comprising at least one quarter-wave conductive spacer configured to stabilize the first microstrip branch feed array with respect to at least one wall of the chamber.

14. The antenna panel of claim 1, further comprising at least one dielectric spacer configured to stabilize positioning of a crossover strip with respect to a support tab.

15. The antenna panel of claim 1, further comprising a radome configured to enclose within a dielectric shell at least the entirety of the radiators and that face of the ground plane that is oriented toward the direction of propagation of the panel, wherein a top and a bottom enclosing element of the radome are each one of integral with the remainder of the radome, integral with the ground plane, a separate component, or omitted, and wherein the radome is physically affixed to one of the panel and a mounting provision.

16. The antenna panel of claim 1, further comprising one of a single vertical row of radiators with a vertical center-to-center spacing approximating one wavelength, the radiators being coupled to two microstrip branch feed arrays, and two parallel, vertical rows of equal numbers of radiators, each row being coupled to two microstrip branch feed arrays, and each row having a vertical center-to-center spacing approximating one wavelength, wherein vertical placement of radiators in two rows is one of each radiator having the same vertical position as one other and each radiator in one row being vertically spaced a half wavelength above or below a proximal radiator in the other row, and wherein lateral spacing between points on the ground plane intersecting the axes of rotational symmetry of proximal radiators is one of approximately one wavelength and a value that establishes approximately a forty-five degree angle between the vertical and a line connecting proximal axes.

17. A method for directing an electromagnetic signal beam with at least one of elliptical, linear, dual orthogonal linear, and dual opposite elliptical polarizations, the method comprising:
configuring at least one interface port to couple an electromagnetic signal for at least one of transmitting and receiving;
defining a conductive ground plane having sufficient length for a plurality of radiators arranged generally in a straight line along the ground plane, the radiators using crossed loop-shaped dipoles and electromagnetically coupled between each monopole and those adjacent thereto by hybrid couplers, the individual crossed-dipole radiators being spaced apart by a distance corresponding to a wavelength of a signal within the bandwidth of the radiators;
providing branch feed distribution of a signal between the interface port and the plurality of defined radiator locations using signal conduction between a microstrip-style signal transport medium and a proximal one of a plurality of walls of a chamber extending at least along the length of the straight line of the ground plane; and
coupling the signal to the radiators using extended conductors, where each extended conductors includes a face that extends the surface of one of the respective microstrips that is oriented toward the proximal chamber wall, each extended conductor traversing a distance parallel to a first support strap with a selected spacing, crossing over to the opposite monopole, traversing a distance parallel to a second support strap with a selected spacing.

18. The method for directing an electromagnetic signal beam of claim 17, further comprising:
providing a second distribution path for a second signal to the second dipoles in the respective radiators.

19. The method for directing an electromagnetic signal beam of claim 18, further comprising:
positioning a second plurality of radiators in a linear array parallel to the radiators in the first linear array, the respective radiators being substantially identical and the second plurality, having vertical positions selected to be one of the same as and half-way between those of the first plurality, and each having a lateral position selected to be one wavelength away from each proximal radiator in the first array and 0.701 wavelengths away therefrom; and
providing distribution paths for a third and a fourth signal to first and second dipoles of the second array of radiators.

20. An antenna panel comprising:
means for configuring at least one interface port to couple an electromagnetic signal for at least one of transmitting and receiving;
means for defining a conductive ground plane having sufficient length for a plurality of radiators arranged generally in a straight line along the ground plane, the radiators using crossed loop-shaped dipoles carried by support straps and electromagnetically coupled between each monopole and those adjacent thereto by hybrid couplers, the individual crossed-dipole radiators being spaced apart by a distance corresponding to a wavelength of a signal within the bandwidth of the radiators;
means for providing branch feed distribution of a signal between the interface port and the plurality of defined radiator locations using signal conduction between a microstrip-style signal transport medium and a proximal one of a plurality of walls of a chamber extending at least along the length of the straight line of the ground plane; and
means for coupling the signal to the radiators using extended conductors fastened to terminal nodes of the transport medium, where each extended conductor includes a face that extends the surface of one of the respective microstrips, each extended conductor passing out of the chamber, traversing a distance parallel to a first support strap with a selected spacing, crossing over to the opposite monopole, traversing a distance parallel to a second support strap with a selected spacing.
